(19) United States
(12) Patent Application Publication
(10) Pub. No.: US 2014/0178158 A1
(43) Pub. Date: Jun. 26, 2014

(54) Robotic instrument rack

(71) Applicants: Michael Mermelstein, Cambridge, MA (US); Charles Cameron Abnet, Waltham, MA (US)

(72) Inventors: Michael Mermelstein, Cambridge, MA (US); Charles Cameron Abnet, Waltham, MA (US)

(21) Appl. No.: 14/099,484

(22) Filed: Dec. 6, 2013

Related U.S. Application Data
(60) Provisional application No. 61/797,413, filed on Dec. 6, 2012.

(51) Int. Cl. G01N 35/00

(52) U.S. Cl. CPC G01N 35/0099
USPC 414/222.01; 414/806

(57) ABSTRACT

The invention provides an improved robotic handler for multi-well plates. The handler comprises a vertical elevator with integral mounts for instruments used in cellular experiments. This solution reduces overall mechanical complexity while reducing the working volume of previous collections of devices with similar function.

### CROSS-REFERENCE TO RELATED APPLICATIONS

This application claims the benefit of provisional patent application Ser. No. 61/797,413, filed Dec. 6, 2012.

### FEDERALLY SPONSORED RESEARCH

Not applicable

### SEQUENCE LISTING OR PROGRAM

Not applicable

### FIELD OF THE INVENTION

This invention relates to a vertical storage rack with an integrated material handler. The system provides multiple mounting locations for instruments including instruments used for cellular measurements and a robotic elevator for supplying the instruments with suitable materials for measurement.

### BACKGROUND OF THE INVENTION

A robot, designed as an automated material handler, is an effective way of increasing the efficiency and throughput of an industrial process. In particular, robots have been very useful in cellular biology by taking over much of the material handling requirements for large scale experiments. In many cases, these experiments are further enabled by using microtiter plates in which many different experiments can be performed in a standard form factor.

The prior art documents many examples of robots capable of handling microtiter plates and being mechanically integrated near instruments so as to move the plates to and from different process steps or instruments. To date, automated, plate handling systems have provided arrangements that attempt to integrate a general purpose robot with conventional instruments. Thus, it is common to see a multi-degree-of-freedom robotic arm in the midst of and serving plates to many different stations arrayed around itself. Some common arrangements will also lay out stations in a linear fashion along a laboratory bench. All these solutions have required a large working volume. In other words, the volume used by the robot to move plates plus the volume occupied by the array of instruments is large.

However, laboratory space is expensive and moving plates large distances is cumbersome and requires safety considerations. Methods to reduce the working volume and complexity of systems are important. High-throughput cell research needs a compact, scalable format for handling microtiter plates among multiple plate-based instruments.

The present invention provides a novel solution that uniquely combines automated plate handling and instrument mounting.

### SUMMARY OF THE INVENTION

The present invention is a robotic system for transporting microtiter plates. The system is configured with a support structure that has mounting locations for multiple instruments used in conjunction with microtiter plates.

The robotic plate transporting system is comprised of several sub-assemblies including a support structure adjacent to a plate elevator. The system components are vertically integrated to conserve lab and bench space. This orientation is a convenient layout for the linear elevator subassembly. The support structure provides the mechanical stability for the plate elevator which is attached to the support at several locations.

The construction of the support structure can be accomplished with a variety of mechanical assemblies. The preferred embodiment includes four vertical struts of extruded aluminum with connective cross-members and sheet components to tie the struts together mechanically forming a stable frame/rack with shelf positions.

The elevator subassembly includes a plate gripper for grabbing and releasing plates and a gripper mount that can move vertically with a carriage along a linear rail. A motor driven belt pulls the carriage along the rail under command from control electronics.

The present invention is constructed and arranged to simplify the task of automating cellular experiments and more particularly to simplify the task of manipulating large numbers of microtiter plates among instrumentation. The robotic system is extremely compact and moves microtiter plates along a well defined trajectory. It combines the tasks of instrument storage and plate handling typically carried out by separate and distinct structures. As a result, it is more space efficient than previous general purpose robotic solutions.

Further objects and advantages will become apparent from the detailed descriptions that follow.

### BRIEF DESCRIPTION OF THE DRAWINGS

FIG. 1 shows an illustration of several instruments mounted in a robotic rack assembly with support struts.

FIG. 2 shows a preferred embodiment of a rack and robotic strut assembly

FIG. 3 shows detail of a instrument shelf with vibration damping

FIG. 4 shows an illustration of a stack of instruments with locating features, an integrated elevator, and vibration damping means.

FIG. 5 shows a robotic rack assembly with safety shield.

FIG. 6 shows a robotic strut assembly

FIG. 7 shows an exploded view of a robotic strut assembly

FIG. 8 shows a preferred gripper assembly

FIG. 9 shows a preferred gripper mount assembly

FIG. 10 shows a side view of a robotic strut assembly

FIG. 11 shows an enlarged side view of a robotic strut assembly

FIG. 12 shows a side view including details for a vertical drive mechanism

### DETAILED DESCRIPTION

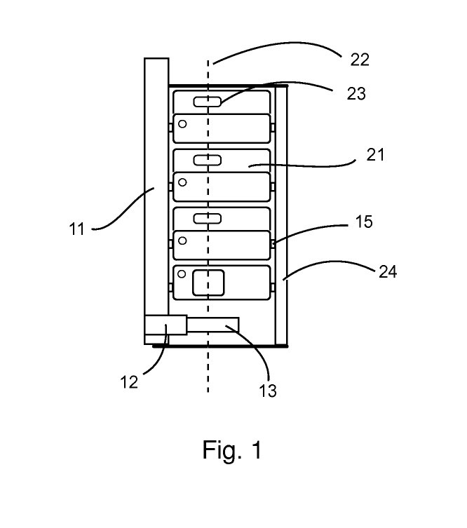

A preferred embodiment of the present invention is illustrated in FIG. 1 with mounted instruments. In this view, instruments, for example 21, are mounted in a rack. The rack structure includes four struts, two of which are visible 11 and 24. Strut 11 is a robotic strut providing both structural support for the rack and serving as a plate elevator. The robotic strut assembly includes a gripper 13 for grasping microtiter plates and a gripper mount 12 which supports the gripper and is mounted to movable components of strut 11. In this case, the movable components move vertically along a linear rail.

Each mounted instrument is supported by two shelves; an example is shown as 15. Each instrument is further characterized by having a port 23, aligned with the vertical path 22 of the gripper, and positioned to receive microtiter plates. The vertical alignment reduces the required working volume of the robotic strut.

An alternative embodiment uses a plate elevator that is not disposed to move vertically along a linear rail but instead grips a plate and moves it among instruments in the vertical rack along a path that is not linear.

### Instrument Rack Assembly

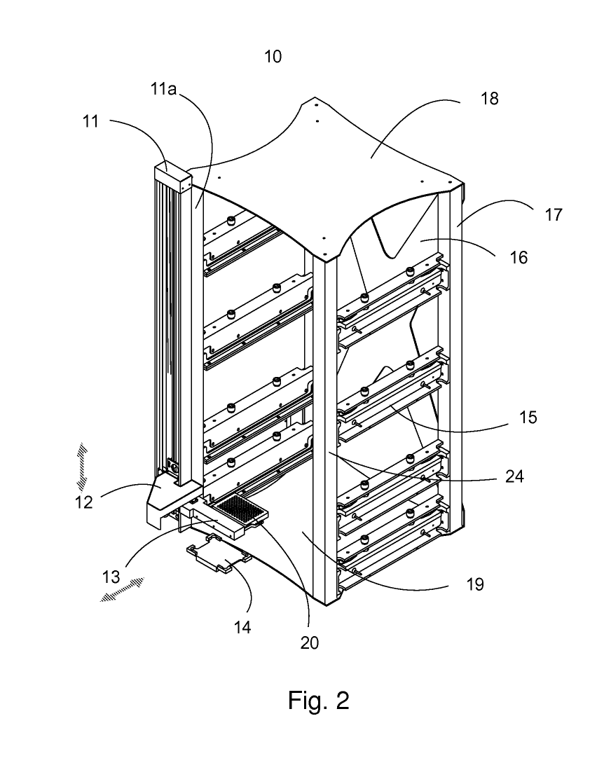

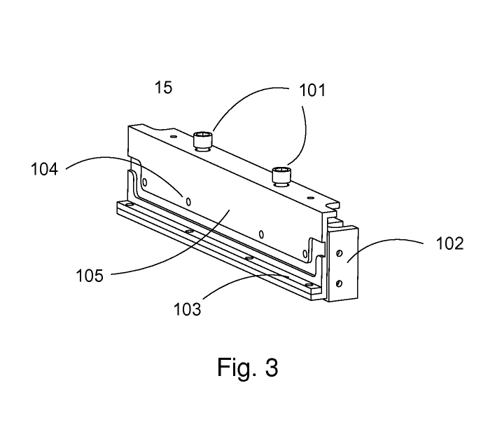

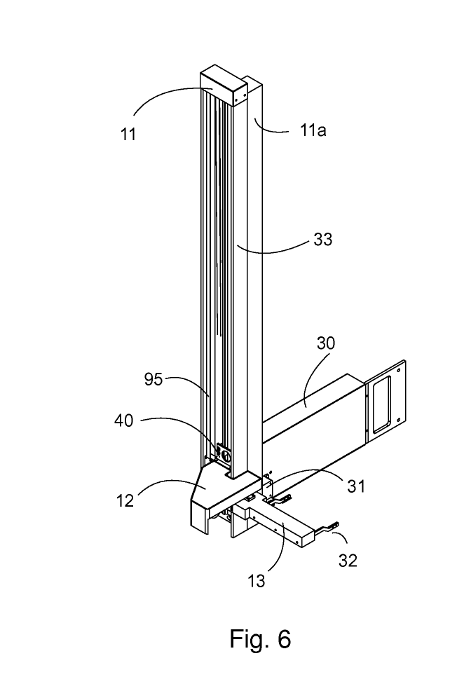

The preferred embodiment 10 is shown in FIG. 2. Robotic rack portion or strut 11 and three additional non-robotic struts including 24 are mechanically bound together with a top plate 18, a bottom plate 19, and a back plate 16 using threaded fasteners, welding, or a combination of both. Robotic strut 11 is configured with a gripper mount 12 and gripper 13. The gripper mount is arranged to move vertically on a carriage and linear rail (not visible) which is mounted on the inside length of U-channel 33, visible in FIG. 6. The U-channel is fixed to an additional vertical support 11a constructed from an extruded aluminum profile. The gripper mount, in turn, provides a means for horizontal linear motion for gripper 13. Instrument mounting shelves, including 15, span rack struts from front to back providing mounting locations and additional structural rigidity to the rack assembly. A fixed platform 14 provides a holding tray for microtiter plates and is used as a hand-off location when interacting with additional robotic plate handlers. For clarity, FIG. 3 shows the preferred embodiment of a mounting shelf 15. The shelf includes a fixed portion 102 which rigidly connects front and back struts. A floating portion 105 is isolated from 102 and external vibration sources by compliant locating structures 101 (e.g. urethane dampers). An instrument (not shown) can be mounted on the shelf lip 103 of floating portion 105 and further located and fastened in place using mounting holes 104.

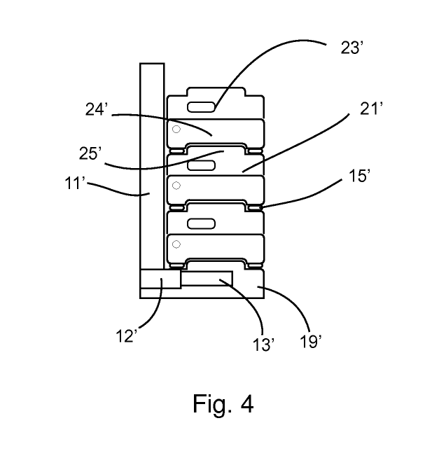

An alternative configuration of instruments is shown in FIG. 4. In this embodiment, instruments, such as 21′, are stacked vertically and both supported and constrained in location by features integral to each instrument. For example, raised feature 25′ is received and interlocked with receptacle feature 24′. Thus, each instrument and its corresponding receiving port 23′ are positioned accurately for subsequent interaction with a robotic elevator assembly including a base structure 19′, vertical riser 11′, gripper mount 12′, and gripper 13′. Interstitial mounting features 15′ provide vibration damping between instruments.

Thus, the present invention provides the functionality of a number of instruments as well as automated material handling for those instruments in only a bit more bench or floor space than a single instrument would take.

### Safety Shield

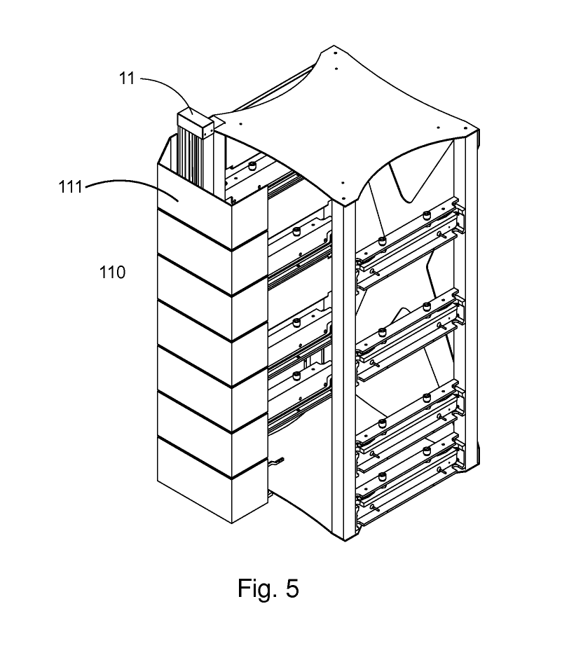

Furthermore, the volume swept out by robot motion is compact and easily and conveniently enclosed by an external or integrated safety shield. A safety shield is desirable to protect persons working near automated equipment from the hazards of the equipment as well as potential hazards associated with biological specimens. Such a shield also reduces contamination from reaching the specimens from the nearby sources. FIG. 5 shows an integrated safety shield 110 composed of tiles 111. The tiled construction is convenient for access to individual instruments, e.g. for maintenance.

### Robotic Rack for Handling Microtiter Plates

The robotic strut 11 is uniquely designed to share a structural role with an instrument rack and to provide a means for precisely handling microtiter plates.

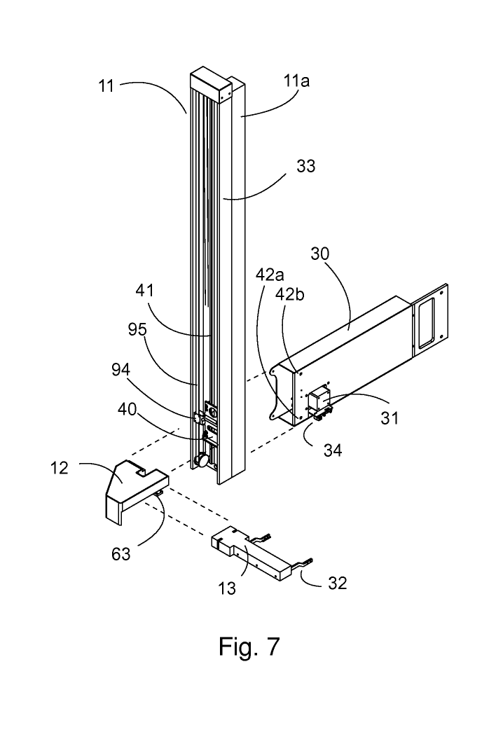

FIG. 6 isolates the robotic strut assembly from the rack mounting positions for clarity and FIG. 7 shows an exploded view of the strut assembly. Gripper 13 is screwed onto drive nut 63 which can be controllably moved. Similarly, gripper mount 12 is screwed to carriage 40, of FIG. 7, which in turn travels along rail 41 sliding on polymer bearing surfaces. The rail 41 is constructed from extruded aluminum and is fastened to the recessed channel of U-channel 33. Carriage 40 is mechanically connected to drive belt 95 by belt clamp 94. Belt 95 is pulled by a drive assembly 30. The relative position of the drive assembly 30 including stepper motor 31 and motor driver 34 is also visible in FIG. 7. The drive assembly 30 is bolted to strut 11 using mount holes 42a and 42b.

In operation, the robotic strut delivers or removes a microtiter plate from a receiving position in a mounted instrument. A microtiter plate 20 (shown in FIG. 2) is gripped by gripper 13 and translated vertically along strut 11 until it is suitably aligned with a receiving port (not shown) of a mounted instrument. The plate then moves horizontally along gripper mount 12 and is deposited in an instrument receptacle (not shown).

### Robotic Rack Components

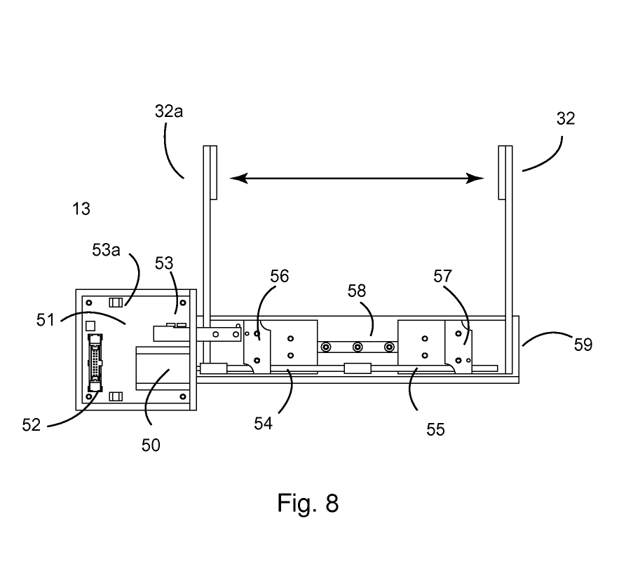

The robotic strut assembly is composed of several sub-assemblies including a gripper 13, a gripper mount 12 and a drive assembly 30 shown in greater detail in FIG. 8 through FIG. 12.

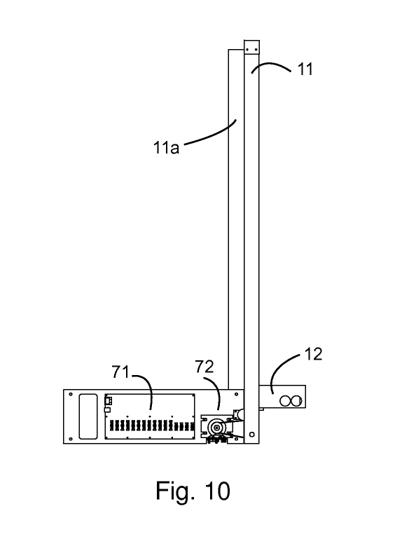

The top view of the preferred gripper assembly 13 is shown in FIG. 8. A left 32a and right 32 jaw are mounted to movable carriages 56 and 57 respectively. Each carriage moves along a portion of a single linear rail 58 mounted to a base platform 59 and is threaded onto a portion of a lead screw. The left lead screw 54 is mechanically coupled to rotate in unison with the right lead screw 55 but is oppositely threaded. A DC motor 50 is coupled to the left lead screw portion 54 and controlled by control board 51. The control board includes optical limit switches 53 and 53a to signal jaw position and gripper assembly position relative to the gripper mount (not shown in FIG. 8). The control board is connected to a power source and central control assembly 71 (shown in FIG. 10) using a suitable cable inserted into receptacle 52.

In operation, a command signal is sent to control board 51 to turn on motor 50. As the motor rotates, coupled lead screws 54 and 55 rotate causing the gripper jaws 32a and 32 to move by driving the carriages 56 and 57 along the rail 58. The direction of jaw motion either increases or decreases the separation of the jaws and is determined by the direction of the motor rotation and relative threading of the lead screws 54 and 55. The jaw motion continues until the optical limit switch 53 is triggered. The arrangement is intended to provide two controlled positions for the jaws: open or closed. In the open position, the jaws can release a microtiter plate or be positioned around a plate. In the closed position, the jaws grip a microtiter plate.

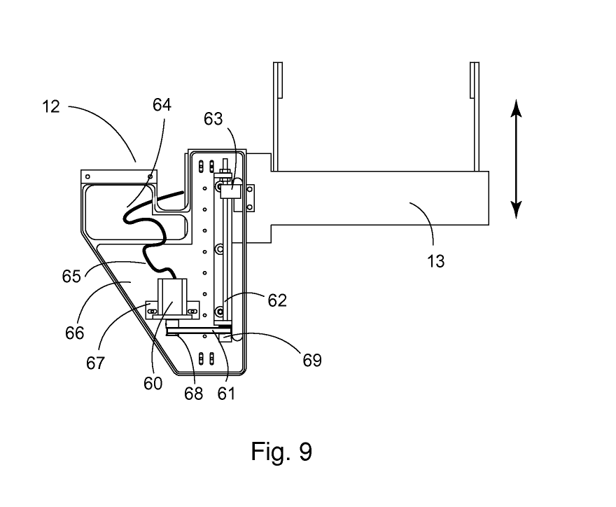

The gripper assembly 13 is in turn mounted to a linearly actuated arrangement on gripper mount 12. FIG. 9 shows the gripper mount and linear actuator assembly. A DC motor 60 is mounted by flange 67 to a structural base 66. A pulley 68 is mounted to the motor and rotates when electrical power is applied to the motor. The motor receives power through cable 65 threaded down through a cable port 64 and connected to control board 51 (not shown in this view). A toothed belt 61 delivers motion from the motor to a pulley 69 attached to lead screw 62 which is also mounted to structural base 66. A drive nut 63 is threaded onto lead screw 62 and mounted to gripper assembly 13.

In operation, electrical current is applied to the motor 60 causing the rotation of pulley 68 which is transferred to pulley 69 by the belt 61. Rotation of pulley 69 turns lead screw 62 and causes drive nut 63 to move linearly along the screw. Thus, attached gripper 13 moves linearly forward or backward as indicated by the arrow.

The preferred gripper mount 12 is attached to a movable carriage 40 housed in strut assembly 11 and driven vertically along the rail 41. FIG. 10 is a sideview of strut assembly 11 showing its orientation relative to components of the vertical drive arrangement 72 and central control assembly 71.

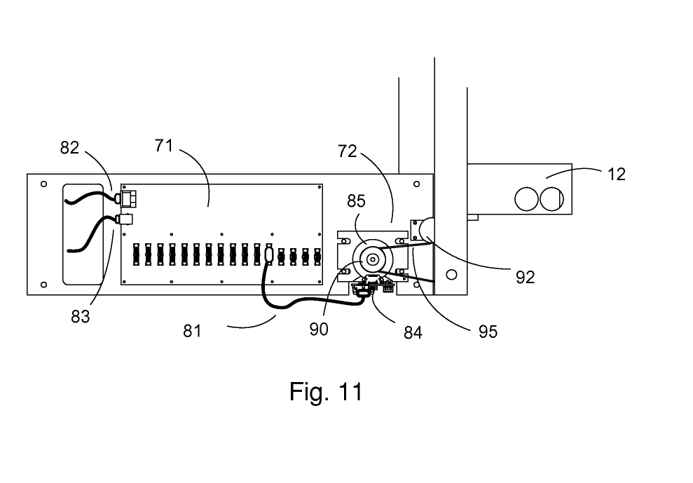

FIG. 11 is an enlarged view of vertical drive components and the central control assembly. The vertical drive is comprised of a stepper motor 31 (not visible) on whose shaft is mounted a drive pulley 90 and an optical encoder disk 85. A toothed drive belt 95 engages pulley 90 and is guided around several idler pulleys including pulley 92. Motor driver and encoder electronics are arranged on driver board 84 which receives power and communication via cable 81 additionally connected to the central control assembly 71. System power and programmatic communication with a personal computer (not shown) are provided by cables 82 and 83 respectively.

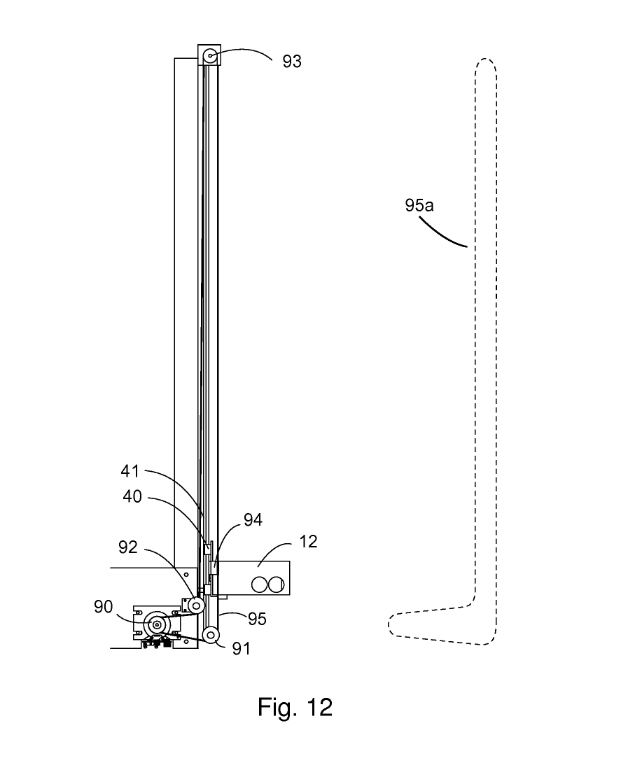

In operation, commands are sent from the central control assembly 71 to driver board 84 and subsequently instruct the stepper motor 31 to rotate. The motor's rotation causes rotation of mounted drive pulley 90 which effectively pulls belt 95. The complete belt path for the vertical drive assembly 95a is shown in FIG. 12. The belt is pulled around idlers 91, 92, and 93 and is attached to carriage 40 by belt clamp 94. Thus, as the belt is pulled, the carriage is pulled vertically along its rail 41. Mechanical friction in the assembly including holding torque of the stepper motor maintains position of the carriage with plate payload.

### ALTERNATIVE DESIGNS AND ASSEMBLIES

Additional alternative designs and assemblies are within the scope of this disclosure and although several are described they are not intended to define the scope of the invention or to be otherwise limiting.

We claim:

1. A system for processing multi-well plates comprising
a plurality of instruments
locating means constructed to locate said plurality of instruments in a vertical stack
controllable elevator means constructed to move plates among said plurality of instruments
wherein said controllable elevator means is substantially adjacent to said vertical stack.

2. The system of claim 1 wherein said locating means comprises a vertical rack.

3. The system of claim 1 wherein said locating means comprises external features of said instruments.

4. The system of claim 1 wherein said locating means additionally locates said controllable elevator means.

5. The system of claim 1 further comprising vibration damping means constructed to damp the vibrations of at least one of said plurality of instruments.

6. The system of claim 1 wherein said plurality of instruments comprises instruments chosen from the list including: plate reader, imager, microscope, cytometer, thermal cycler, liquid handler, incubator, hotel, lid handler, seal handler.

7. The system of claim 1 wherein said multi-well plates are selected from the list including microtiter plates, microarray chips, microfluidic chips, microscope slide carriers.

8. The system of claim 1 further comprising a hand-off location.

9. The system of claim 1 further comprising a safety shield constructed to enclose at least a portion of the working volume of said controllable elevator means.

10. The system of claim 9 wherein said safety shield comprises a plurality of tiles.

11. A method for processing a multi-well plate comprising the steps of
providing locating means constructed to locate a plurality of instruments in a vertical stack
providing controllable elevator means substantially adjacent to said vertical stack and constructed to move plates among said plurality of instruments
providing a multi-well plate
providing at least one instrument
locating said at least one instrument using said locating means
processing said multi-well plate using said at least one instrument

12. The method of claim 11 further comprising the step of moving said multi-well plate to said at least one instrument using said controllable elevator means

13. The method of claim 11 wherein said locating means comprises a vertical rack.

14. The method of claim 11 wherein said locating means comprises external features of said instruments.

15. The method of claim 11 further comprising the step of providing vibration damping means constructed to damp the vibrations of said at least one instrument.

16. The method of claim 11 wherein said at least one instrument is chosen from the list including: plate reader, imager, microscope, cytometer, thermal cycler, liquid handler, incubator, hotel, lid handler, seal handler.

17. The method of claim 11 wherein said multi-well plate is selected from the list including microtiter plate, microarray chip, microfluidic chip, microscope slide carrier.

18. The method of claim 11 further comprising the steps of:
providing a hand-off location
positioning said multi-well plate in said hand-off location
moving said multi-well plate from said hand-off location using said controllable elevator means

19. The method of claim 11 further comprising the step of providing a safety shield constructed to enclose at least a portion of the working volume of said controllable elevator means.

20. The method of claim 19 wherein said safety shield comprises a plurality of tiles.
